(19) United States
(12) Patent Application Publication
(10) Pub. No.: US 2014/0321164 A1
(43) Pub. Date: Oct. 30, 2014

(54) COMPOSITE LIGHT GUIDE PLATE, DEVICE AND METHOD FOR MAKING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 14/259,164

(22) Filed: Apr. 23, 2014

(30) Foreign Application Priority Data
Apr. 26, 2013 (TW) 102115180

(51) Int. Cl. F21V 8/00

(52) U.S. Cl. CPC G02B 6/0065
USPC 362/629; 425/131.1; 264/1.29

(57) ABSTRACT

Composite light guide plate includes a substrate, a first transparent layer, and a second transparent layer. The substrate includes an upper surface and an opposite lower surface. The substrate is made of polycarbonate, and a number of diffusion particles made of polymethyl methacrylate are embedded in the substrate. The first transparent layer is made of polystyrene formed on the upper surface. The second transparent layer made of polystyrene is formed on the lower surface.

### FIELD

The present disclosure relates to optic technologies and, particularly, to a composite light guide plate, a device for making the light guide plate, and a method for making the light guide plate using the device.

### BACKGROUND

A backlight module includes a reflector, a light guide plate, a bottom diffuser, a first prism, a second prism, and an upper diffuser. The reflector faces a reflecting surface of the light guide plate. The bottom diffuser, the first prism, the second prism, and the upper diffuser are stacked on a light output surface of the light guide plate in that order.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is schematic view of a composite light guide plate, according to an exemplary embodiment.

FIG. 2 is a schematic view of a device for making the composite light guide plate of FIG. 1, according to another exemplary embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

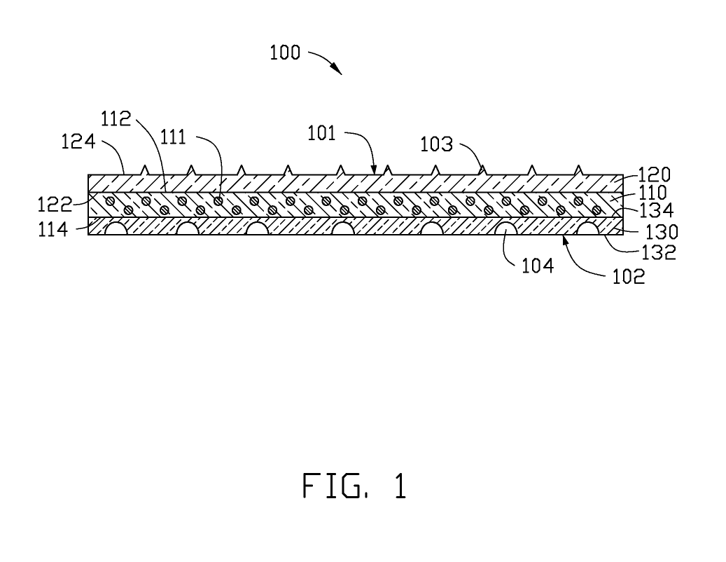

FIG. 1 illustrates a composite light guide plate 100 in accordance with an exemplary embodiment. The composite light guide plate 100 includes a substrate 110, a first transparent layer 120 and a second transparent layer 130. The transparent layer 120 and the second transparent layer 130 are positioned at opposite sides of the substrate 110, and the first transparent layer 120 is substantially parallel to the second transparent layer 130.

The substrate 110 includes an upper surface 112 and a lower surface 114. The upper surface 112 and the lower surface 114 are positioned at opposite sides of the substrate 110, and the upper surface 112 is substantially parallel to the lower surface 114. The substrate 110 is made of polycarbonate (PC). A number of diffusion particles 111 made of polymethyl methacrylate (PMAA) are embedded in the substrate 110. The diameter of each diffusion particle 111 is in a range from 0.5 micrometers to 50 micrometers. In other embodiments, the diffusion particles 111 can be made of silicon dioxide.

The first transparent layer 120 is made of polystyrene, and includes a top surface 124 and a bottom surface 122. The top surface 124 and the bottom surface 122 are positioned at opposite sides of the first transparent layer 120, and the top surface 124 is substantially parallel to the bottom surface 122. The bottom surface 122 is directly adhered on the upper surface 112. The top surface 124 faces away from the upper surface 112, and serves as a light output surface of the composite light guide plate 100. A number of protrusions 103 are formed on the top surface 124 and are arranged in a matrix. Each of the protrusions 103 is substantially cone-shaped.

The second transparent layer 130 is made of polystyrene (PS), and includes a first surface 132 and a second surface 134. The first surface 132 and the second surface 134 are positioned at opposite sides of the second transparent layer 130, and the first surface 132 is substantially parallel to the second surface 134. The second surface 134 is directly adhered on the lower surface 114. The first surface 132 faces away from the lower surface 114, and serves as a reflecting surface of the composite light guide plate 100. A number of grooves 104 are formed on the first surface 132 and are arranged in a matrix. Each of the grooves 104 is substantially hemispherical.

The protrusions 103 and the grooves 104 are not limited in the shapes disclosed in this embodiment.

The composite light guide plate 100 is composed of the substrate 110, the first transparent layer 120, and the second transparent layer 130. When the composite light guide plate 100 is used in a backlight module, there is no need to include a first prism, a second prism, and a bottom diffuser in the backlight module, and the first transparent layer 120 and the transparent layer 130 can be in tight contact with the substrate 110, therefore, the backlight module can be thin.

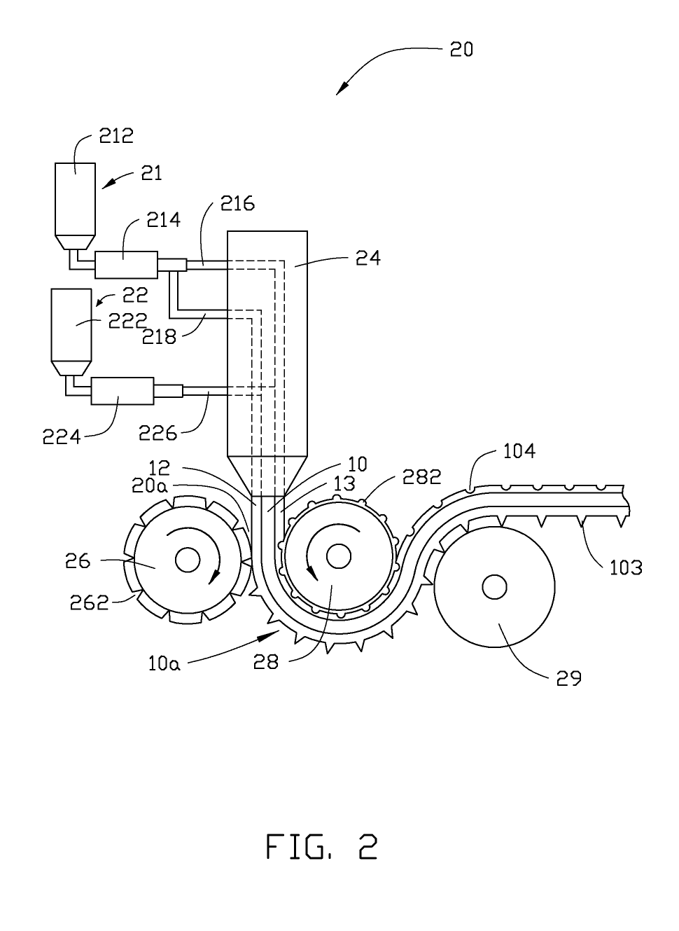

FIG. 2 shows a device 20 for making the composite light guide plate 100 according to another exemplary embodiment. The device 20 includes a first feed unit 21, a second feed unit 22, a stacked die 24, a first pressing roller 26, a second pressing roller 28, and a transmission roller 29.

The first feed unit 21 includes a first tank 212, a first extrusion screw 214, a first tube 216, and a second tube 218. The first tank 212 is configured to contain hot melted polystyrene. The first tube 216 and the second tube 218 branch from the first tank 212. The first extrusion screw 214 is mounted between the first tank 212 and the joint of the first tube 216 and the second tube 218, and is configured to squeeze the hot melted polystyrene from the first tank 212 into the first tube 216 and the second tube 218.

The second feed unit 22 includes a second tank 222, a second extrusion screw 224, and a third tube 226. The second tank 222 is configured to contain hot melted polycarbonate mixed with polymethyl methacrylate. The third tube 226 extends from the first tank 212. The first extrusion screw 214 is mounted on the third tube 226, and is configured to squeeze the hot melted polycarbonate mixed with polymethyl methacrylate from the second tank 222 into the third tube 226.

The stacked die 24 is positioned nearby the first feed unit 21 and the second feed unit 22. In detail, the first feed unit 21 and the second feed unit 22 are arranged in the same side of the stack die 24, and the feed unit 21 is positioned above the second feed unit 22. The first tube 216, the second tube 218, and the third tube 226 extend into the stacked die 24. The stacked die 24 combines the polystyrene from the first tube 216 and the second tube 218 and the polycarbonate mixed with polymethyl methacrylate from the third tube 226 together and pre-cools them to get a pre-cooled plate 10a. The pre-cooled plate 10a includes a middle portion 10, a first portion 12 and a second portion 13. The middle portion 10 is made of the polycarbonate mixed with polymethyl methacrylate from the third tube 226. The first portion 12 is positioned at one side of the middle portion 10, and is made of polystyrene from the second tube 218. The second portion 13 is positioned at the other side of the middle portion 10, and is made of polystyrene from the first tube 216.

The first pressing roller 26 and the second pressing roller 28 are positioned under the stacked die 24. The first pressing roller 26 defines a first central axis (not labeled and perpendicular to the paper) in a central portion and rotates about the first central axis. The second pressing roller 28 defines a second central axis (not labeled and perpendicular to the paper) in a central portion and rotates about the second central axis. The first central axis and the second central axis are arranged on a same plane, such as a common horizontal plane, and can be parallel to each other. A rotating direction of the first pressing roller 26 is reverse to the direction of the rotation of the second pressing roller 28. In this embodiment, the first pressing roller 26 rotates clockwise, and the second pressing roller 28 rotates counterclockwise.

In the illustrated embodiment, the first pressing roller 26 and the second pressing roller 28 are located nearby each other and spaced a predetermined distance from each other. A channel 20a is formed between the first pressing roller 26 and the second pressing roller 28. The stacked die 24 is aligned with the channel 20a. The pre-cooled plate 10a enters the channel 20a. The distance between the first pressing roller 26 and the second pressing roller 28 is substantially equal to a predetermined thickness of the pre-cooled plate 10a to be manufactured.

The first pressing roller 26 and the second pressing roller 28 cooperate to press the pre-cooled plate 10a. The first pressing roller 26 defines a number of first recesses 262 on an outer circumferential surface. In the illustrated embodiment, each of the first recesses 262 is substantially cone-shaped.

A number of microstructures 282 are formed on an outer circumferential surface of the second pressing roller 28. In the illustrated embodiment, each of the microstructures 282 is substantially a dot-shaped protrusion.

The transmission roller 29 is a hollow cylinder and positioned nearby the second pressing roller 28. The transmission roller 29 defines a third central axis (not labeled and perpendicular to the paper) in a central portion and rotates about the third central axis. The third central axis and the second central axis are arranged on a same plane, such as a common horizontal plane, and can be parallel to each other. The transmission roller 29 is configured for transmitting the pre-cooled plate 10a to a winding roller (not shown). The winding roller is configured for winding up the pre-cooled plate 10a.

Referring to FIGS. 1-2, a method for making the composite light guide plate 100 is shown. The method includes the following steps.

In step I, the device 20 is provided.

In step II, polystyrene from the first tank 212 is introduced into the stacked die 24 through the first tube 216 and the second tube 218, and the polycarbonate mixed with polymethyl methacrylate from second tank 222 is introduced into the stacked die 24 through the third tube 226.

In step III, a pre-cooled plate 10a is formed by the stacked die 24. The pre-cooled plate 10a includes a middle portion 10, a first portion 12 and a second portion 13. The middle portion 10 is made of the polycarbonate mixed with polymethyl methacrylate from the third tube 226. The first portion 12 is positioned at one side of the middle portion 10, and is made of polystyrene from the second tube 218. The second portion 13 is positioned at the other side of the middle portion 10, and is made of polystyrene from the first tube 216.

In step IV, the first pressing roller 26 and the second pressing roller 28 are rotated in reverse directions from each other. In this embodiment, the first pressing roller 26 rotates clockwise, and the second pressing roller 28 rotates counterclockwise.

In step V, the pre-cooled plate 10a is introduced into the channel 20a from the stacked die 24 and pressed by the first pressing roller 26 and the second pressing roller 28 to print protrusions 103 and grooves 104 on opposite surfaces of the pre-cooled plate 10a.

In step VI the pre-cooled plate 10a is solidified by UV light beams to form the composite light guide plate 100. Two UV lamps (not shown) can implement this step.

In step VII, the composite light guide plate 100 is transmitted using the transmission roller 29.

In step VIII, the composite light guide plate 100 is wound up using a winding roller (not shown).

Even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A composite light guide plate, comprising:
a substrate comprising an upper surface and a lower surface at opposite sides thereof, the substrate made of polycarbonate, and the substrate comprising a plurality of diffusion particles made of polymethyl methacrylate and embedded in the substrate;
a first transparent layer made of polystyrene and formed on the upper surface; and
a second transparent layer made of polystyrene and formed on the lower surface.

2. The composite light guide plate of claim 1, wherein the first transparent layer comprises a top surface and a bottom surface at opposite sides thereof, the bottom surface is adhered on the upper surface, and a plurality of protrusions are formed on the top surface and arranged in a matrix.

3. The composite light guide plate of claim 2, wherein each of the protrusions is substantially cone-shaped.

4. The composite light guide plate of claim 2, wherein the second transparent layer comprises a first surface and a second surface at opposite sides thereof, the second surface is adhered on the lower surface, and a plurality of grooves are defined on the first surface and arranged in a matrix.

5. The composite light guide plate of claim 4, wherein each of the grooves is substantially hemispherical.

6. The composite light guide plate of claim 1, wherein the diameter of each of the diffusion particles is in a range from 0.5 micrometers to 50 micrometers.

7. A device for making a composite light guide plate, comprising:
a first feed unit configured for supplying two streams of hot melted polystyrene;
a second feed unit configured for supplying hot melted polycarbonate mixed with polymethyl methacrylate between the two streams of hot melted polystyrene;
a stacked die configured for combining and pre-cooling the two streams of hot melted polystyrene and the hot melted polycarbonate mixed with polymethyl methacrylate to get a pre-cooled plate;
a first pressing roller defining a first central axis, the first pressing roller defining a plurality of first recesses on an outer circumferential surface thereof, the first pressing roller configured for rotating about the first central axis in a first direction; and
a second pressing roller defining a second central axis, the second pressing roller having a plurality of microstructures on an outer circumferential surface thereof, the second pressing roller configured for rotating about the second central axis in a second direction reverse to the first direction, the first central axis and the second central axis arranged on a common horizontal plane and parallel to each other, a channel defined between the first pressing roller and the second pressing roller, the first pressing roller and the second pressing roller cooperatively pressing the pre-cooled plate entering the channel from the stacked die.

8. The device of claim 7, wherein the first feed unit comprises a first tank, a first extrusion screw, a first tube, and a second tube, the first tank is configured to contain the hot melted polystyrene, the first tube and the second tube branch from the first tank, the first extrusion screw is mounted between the first tank and the joint of the first tube and the second tube, and is configured to squeeze the hot melted polystyrene from the first tank into the first tube and the second tube.

9. The device of claim 8, wherein the second feed unit comprises a second tank, a second extrusion screw, and a third tube, the second tank is configured to contain the hot melted polycarbonate mixed with polymethyl methacrylate, the third tube extends from the first tank, the first extrusion screw is mounted on the third tube, and is configured to squeeze the hot melted polycarbonate mixed with polymethyl methacrylate from the second tank into the third tube.

10. The device of claim 9, further comprising a transmission roller, wherein the transmission roller defines a third central axis, the third central axis and the second central axis are arranged on a common horizontal plane and parallel to each other, the transmission roller is configured for transmitting the pre-cooled plate.

11. A method for making a composite light guide plate, comprising:
providing a device, the device comprising a first feed unit configured for supplying two streams of hot melted polystyrene; a second feed unit configured for supplying hot melted polycarbonate mixed with polymethyl methacrylate between the two streams of hot melted polystyrene; a stacked die configured for combining and pre-cooling the two streams of hot melted polystyrene and the hot melted polycarbonate mixed with polymethyl methacrylate to get a pre-cooled plate; a first pressing roller defining a first central axis, the first pressing roller defining a plurality of first recesses on an outer circumferential surface thereof, the first pressing roller configured for rotating about the first central axis in a first direction; and a second pressing roller defining a second central axis, the second pressing roller having a plurality of microstructures on an outer circumferential surface thereof, the second pressing roller configured for rotating about the second central axis in a second direction reverse to the first direction, the first central axis and the second central axis arranged on a common horizontal plane and parallel to each other, a channel defined between the first pressing roller and the second pressing roller, the first pressing roller and the second pressing roller cooperatively pressing the pre-cooled plate entering the channel from the stacked die;
intruding two streams of hot melted polystyrene from the first tank and hot melted polycarbonate mixed with polymethyl methacrylate from the second tank into the stacked die;
forming a pre-cooled plate using the stacked die;
rotating the first pressing roller in the first direction and the second pressing roller in the second direction; and
introducing the pre-cooled plate into the channel and pressing the pre-cooled plate using the first pressing roller and the second pressing roller to print protrusions and grooves on opposite surfaces of the pre-cooled plate to form the composite light guide plate.

12. The method of claim 11, wherein the first feed unit comprises a first tank, a first extrusion screw, a first tube, and a second tube, the first tank is configured to contain the hot melted polystyrene, the first tube and the second tube branch from the first tank, the first extrusion screw is mounted between the first tank and the joint of the first tube and the second tube, and is configured to squeeze the hot melted polystyrene from the first tank into the first tube and the second tube.

13. The method of claim 12, wherein the second feed unit comprises a second tank, a second extrusion screw, and a third tube, the second tank is configured to contain the hot melted polycarbonate mixed with polymethyl methacrylate, the third tube extends from the first tank, the first extrusion screw is mounted on the third tube, and is configured to squeeze the hot melted polycarbonate mixed with polymethyl methacrylate from the second tank into the third tube.

14. The method of claim 13, further comprising a transmission roller, wherein the transmission roller defines a third central axis, the third central axis and the second central axis are arranged on a common horizontal plane and parallel to each other, the transmission roller is configured for transmitting the pre-cooled plate.
